(19) United States
(12) Patent Application Publication
(10) Pub. No.: US 2008/0175423 A1
(43) Pub. Date: Jul. 24, 2008

(54) Adjusting a hearing apparatus to a speech signal

(76) Inventor: Volkmar Hamacher, Neunkirchen am Brand (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/986,839

(22) Filed: Nov. 27, 2007

(30) Foreign Application Priority Data
Nov. 27, 2006 (DE) 102006055935.5

(51) Int. Cl. H04R 25/00

(52) U.S. Cl. 381/317; 381/312

(57) ABSTRACT

The speech recognition in a background noise-filled environment is to be improved. To this end, provision is made to record a speech signal of a predetermined speaker when adjusting a hearing apparatus and in particular a hearing device to a user and to analyze this speech signal. Within the scope of the adjustment, a signal processing algorithm of the hearing apparatus is then to be set as a function of the analysis result.

### CROSS REFERENCE TO RELATED APPLICATIONS

This application claims priority of German application No. 102006055935.5 DE filed Nov. 27, 2006, which is incorporated by reference herein in its entirety.

### FIELD OF INVENTION

The present invention relates to an adjustment method for adjusting a hearing apparatus to a user. Furthermore, the present invention relates to a corresponding adjustment apparatus as well as to a method for operating the hearing apparatus and to the hearing apparatus itself. The term hearing apparatus is understood here to mean in particular a hearing device, but also earphones, a headset or suchlike.

### BACKGROUND OF INVENTION

Hearing devices are wearable hearing apparatuses used to assist the hard-of-hearing. To meet the numerous individual requirements, different designs of hearing device are provided, such as behind-the ear (BTE) hearing devices, in-the-ear (ITE) hearing devices and concha hearing devices. The typical configurations of hearing device are worn on the outer ear or in the auditory canal. Above and beyond these designs however there are also bone conduction hearing aids, implantable or vibro-tactile hearing aids available on the market. In such hearing aids the damaged hearing is stimulated either mechanically or electrically.

Hearing devices principally have as their main components an input converter, an amplifier and an output converter. The input converter is as a rule a sound receiver, e.g. a microphone, and/or an electromagnetic receiver, e.g. an induction coil. The output converter is mostly implemented as an electroacoustic converter, e.g. a miniature loudspeaker, or as an electromechanical converter, e.g. bone conduction earpiece. The amplifier is usually integrated into a signal processing unit. This basic structure is shown in FIG. 1 using a behind-the ear hearing device as an example. One or more microphones 2 for recording the sound from the surroundings are built into a hearing device housing 1 worn behind the ear. A signal processing unit 3, which is also integrated into the hearing device housing 1, processes the microphone signals and amplifies them. The output signal of the signal processing unit 3 is transmitted to a loudspeaker or earpiece 4 which outputs an acoustic signal. The sound is transmitted, if necessary via a sound tube which is fixed with an otoplastic in the auditory canal, to the hearing device wearer's eardrum. The power is supplied to the hearing device and especially to the signal processing unit 3 by a battery 5 also integrated into the hearing device housing 1.

Speech recognition in an environment which is filled with background noise nowadays still constitutes the biggest problem of hearing device wearers. This means that background noise suppression in hearing devices has to be further improved. This applies in particular to background noise reduction algorithms in hearing devices without directional microphones.

No noteworthy improvements to speech comprehensibility could previously be proven for the background noise reduction methods established in hearing devices (e.g. Wiener filter), but also for the more complex algorithms proposed within the field of science (e.g. Ephraim-Malah). The said algorithm is described in the article Y. Ephraim and D. Malah, “Speech enhancement using a minimum mean-square error short-time spectral amplitude estimator,” IEEE Trans. Acoust., Speech, Signal Processing, vol. 32, no. 6, pp. 1109-1121, 1984. Investigations have shown that signal-to-noise ratio improvements can be achieved using more accurate (non-individualized) amplitude-statistical features. This supports the publication by Th. Lotter: “Single and multimicrophone speech enhancement for hearing aids”, 2004, Verlag Mainz, Aachen, ISBN 3.186130-645-X.

The benefit of a high-quality background noise reduction method mainly consists in improved speech quality and reduced nuisance from background interference. The main problem lies in estimating the background noise parts in the microphone signal. Nowadays this is generally carried out on a signal-statistical basis using the stationarity as a single separation criterion. In this process, advantage is taken of the fact that background noises mostly exhibit a stationary envelope curve, whereas speech signals are non-stationary. Further differentiating assumptions in respect of both signals are not made.

The publication DE 101 14 101 A1 discloses a method for processing an input signal in a signal processing unit of a hearing device. Adjustment parameters of the signal processing unit, which relate to the directional characteristics, the frequency response, the signal increase, the choice of hearing program or the background noise reduction, are set as a function of the result of a signal analysis of the input signal. In this way, the signal analysis includes at least one modulation analysis, which shows particular advantages in respect of the difference between background and useful signals. In particular, it is possible to determine by means of the modulation analysis whether and to what degree speech or other signals such as music or interference signals are present in the input signals.

The publication EP 1 359 787 A2 also discloses an adjustment method based on a signal-to-noise ratio. In a classifier, acoustic categories such as speech, car noise, music etc. are individually trained.

### SUMMARY OF INVENTION

The object of the present invention thus consists in improving the speech recognition in background noise-filled environments for users of hearing apparatuses and in particular of hearing devices.

This object is achieved in accordance with the invention by an adjustment method for adjusting a hearing apparatus to a user by recording a speech signal of a predetermined speaker, analyzing the speech signal by providing a corresponding speaker-specific analysis result and adjusting an algorithm in order to reduce background noises of the hearing apparatus as a function of the speaker-specific analysis result.

In addition, an adjustment apparatus for adjusting a hearing apparatus to a user with a sound provision facility for providing a speaker-specific speech signal of a predetermined speaker, an analysis facility for analyzing the speech signal and a transmission facility for transmitting the speaker-specific analysis result of the analysis facility to the hearing apparatus is proposed according to the present invention.

It is thus advantageously possible during the adjustment procedure to “train” a hearing apparatus specially to an individual speaker. During the adjustment procedure, a preferred sound, i.e. the speech signal of the desired speaker, can be analyzed in detail, so that the features of the speech signal can be used to control the hearing apparatus. It is more easily possible to obtain the undisturbed speech signals of the desired speaker and to correspondingly accurately analyze them during the adjustment procedure. In practice, this is almost or completely impossible when the device is in operation.

The analysis result from analyzing the speech signal preferably includes an amplitude distribution, a long-term spectrum, a bandwidth and/or a modulation value. These features can be used to emphasize the speech of the desired speaker accordingly.

If the feature or features of a speech signal of the desired speaker are obtained with the aid of the above-illustrated inventive adjustment method and/or the adjustment device and are used in the hearing apparatus to set a signal processing algorithm, interference signals can be reduced in a more targeted fashion during operation of the hearing apparatus. On the one hand, the speech signal can be emphasized compared with other background noises. On the other hand, it is however also possible to reduce the speech signal of the predetermined speaker as far as possible, in order to be able to emphasize other sounds and/or to perceive these in an undisturbed fashion.

In particular, a background noise algorithm can be implemented in the hearing apparatus, which uses the amplitude distribution of the speech signal (e.g. Ephraim-Malah method). It is herewith then particularly advantageous if the analysis result includes an amplitude distribution of the speech signal and if this amplitude distribution is used for the background noise elimination algorithm. The signal-to-noise ratio can herewith be considerably improved in the case of speech.

### BRIEF DESCRIPTION OF THE DRAWINGS

The present invention is described in more detail with reference to the appended drawings, in which;

FIG. 1 shows the main design of a hearing device with its essential components and

FIG. 2 shows a signal flow diagram of an inventive adjustment process including the processing in a hearing device.

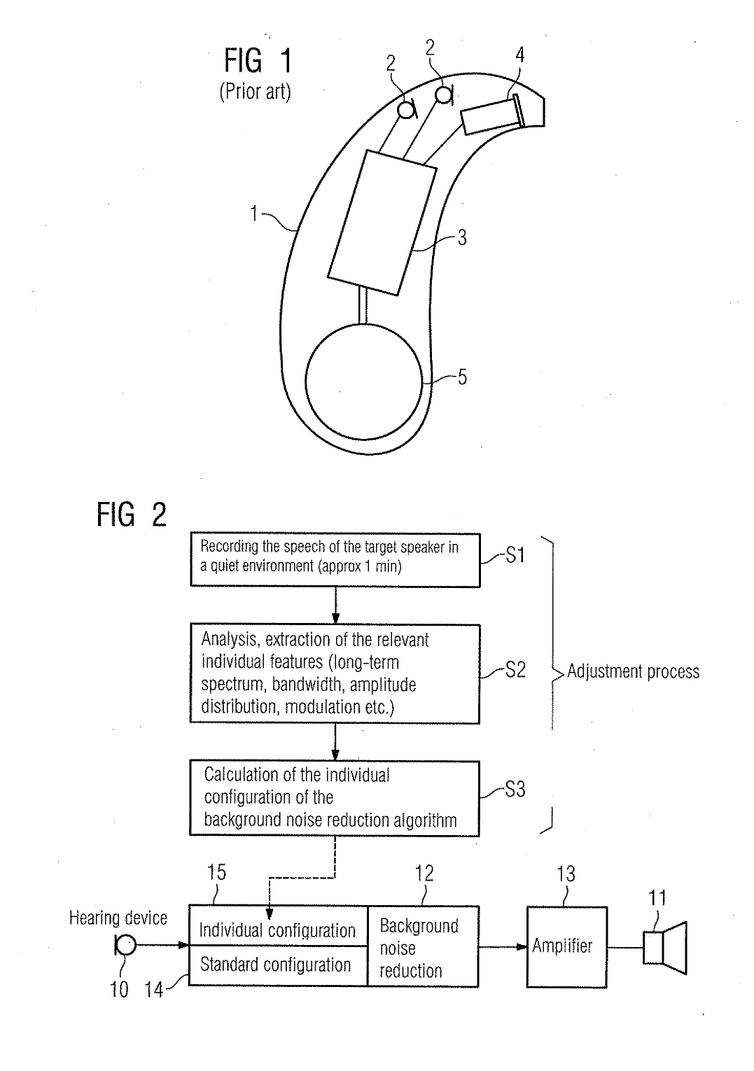

### DETAILED DESCRIPTION OF INVENTION

The exemplary embodiment illustrated in more detail below represents a preferred embodiment of the present invention.

The basic idea of the present invention is to make knowledge specific to the speech signal of the speaker and obtained in the manner of a training phase available to the hearing apparatus and/or the hearing device for hearing situations with the known speaker. This specific knowledge includes physical features of the speech spoken known speaker. Typical features which characterize the speech signals are the long-term spectrum, the bandwidth, the amplitude distribution, the modulation and suchlike.

As shown in FIG. 2, with the inventive adjustment process according to step S1, the speech of the target speaker is recorded in a quiet environment. To this end, a recording of approximately 1 minute in length is sufficient for instance. It is important to record the speech in a sufficiently quiet environment so that as undisturbed a signal as possible is available for the analysis. In practice, the hearing device wearer will bring his/her partner to the adjustment session for instance in order to allow his/her speech signals to be recorded. Alternatively, he/she can however also bring along a recording of the voice of the partner and/or the desired person to the adjustment session for instance.

The recorded speech signal is now analyzed in a second step S2 of the adjustment process. In this process, relevant, individual features of the speech signal are extracted. As was already indicated above, these features can be the long-term spectrum, the bandwidth, the amplitude distribution or the modulation for instance. All this information is generally already characteristic per se of the speech of an individual person. However, the more information relating to the speech that can be obtained, the better a corresponding speech signal can be detected for the further processing.

Parameters for a background noise reduction algorithm are calculated in step S3 from information relating to the speech signal which is obtained from step S2. In this way, an individual configuration of the background noise reduction algorithm can be found as early as during the adjustment process.

To complete the adjustment process, the configuration of the background noise algorithm determined in step S3 is transmitted to the hearing device, as is shown in FIG. 2 with the dashed arrow.

FIG. 2 shows a schematic representation of the hearing device with a few function blocks. The microphone 10 symbolizes the signal input. Furthermore, the receiver 11 indicates the signal output of the hearing device. Signal processing components such as for instance the background noise reduction algorithm 12 are located therebetween for instance. This provides for the signal of the microphone 10 to be freed of background noises and to be forwarded to an amplifier 13. The amplifier 13 for its part supplies a hearing device output signal to the receiver 11.

The background noise reduction algorithm 12 can be operated using a standard configuration, which is stored in a first memory 14. In a second memory 15, an individual configuration is stored, which contains parameters which are obtained from the adjustment process. While the standard configuration contains basic configuration data, which is necessary for the basic operation of the background noise algorithm, the individual configuration even contains the individual features for instance which were obtained in step S2 of the adjustment process from the speech signal of the desired speaker, and/or the parameters calculated from these features in step S3. The background noise reduction is then carried out on the basis both of the standard configuration as well as the individual configuration. The thus individually configured background noise algorithm allows an improved extraction of the speech signal to be achieved.

With the usual spectral weighting method, the individual configuration would relate to the blocks “interference evaluation”, “weighting formula” and “post-processing”. The weighting formula of the Ephraim Malah method concretely requires the amplitude distribution of the useful signal, where in other respects, a Gauss distribution is generally adopted. To this end, the individual amplitude distribution is thus predetermined for the concrete preferred speaker in the training phase in step S2, as illustrated in FIG. 2. The amplitude-statistical features of the speech of the desired speaker then allow the speech signal of this speaker to be output in the hearing device in an amplified manner with an improved signal-to-noise ratio.

The features and/or noise reduction parameters in respect of the speech signal, obtained in the adjustment process, can also be used to assess the speech of the known speaker as interference and to suppress a corresponding speech signal as far as possible.

It is essentially also conceivable, this however not being claimed here, to allow the current speech signal to be ideally analyzed in a quiet environment, in response to a special control command in a hearing device, e.g. with the remote controller. The individual features thus obtained can then be used subsequently with the background noise reduction. This could also be extended to sounds other than the preferred voice.

1.-8. (canceled)

9. An adjustment method for adjusting a hearing apparatus to a user, comprising:
recording of a speech signal of a predetermined speaker;
producing a speaker-specific analysis result of the speech signal; and
setting of an algorithm in order to reduce background noises of the hearing apparatus as a function of the speaker-specific analysis result.

10. The adjustment method as claimed in claim 9, wherein the analysis result includes at least an amplitude distribution, a long-term spectrum, a bandwidth or a modulation value.

11. An adjustment apparatus for adjusting a hearing apparatus to a user, comprising:
a sound provision facility for providing a speech signal of a predetermined speaker;
an analysis facility for analyzing the speaker-specific speech signal; and
a transmission facility for transmitting the speaker-specific analysis result of the analysis facility to the hearing apparatus.

12. The adjustment apparatus as claimed in claim 11, wherein the analysis result includes at least one of the characteristics selected from amplitude distribution, long-term spectrum, bandwidth and modulation value.

13. A hearing apparatus, comprising:
a microphone for receiving a first signal;
a first memory comprising a standard configuration;
a second memory comprising an individual configuration, the individual configuration obtained via an adjustment apparatus, wherein a speech signal of a predetermined speaker is analyzed and the speaker-specific analysis result is stored in the second memory; and
a background noise elimination facility that uses the first and second memories in order to eliminate background noise from the received from the first signal.

14. The hearing apparatus as claimed in claim 13, wherein an amplitude distribution of the speech signal is stored in the second memory and is used by the background noise elimination facility to eliminate background noise.
